(19) United States
(12) Patent Application Publication
(10) Pub. No.: US 2021/0238518 A1
(43) Pub. Date: Aug. 5, 2021

(54) METHOD AND APPARATUS FOR PRODUCING SOTOL

(71) Applicant: CKL Distilling, LLC d/b/a Desert Door, Driftwood, TX (US)

(72) Inventors: Brent Looby, Austin, TX (US); Ryan Campbell, San Antonio, TX (US); Judson Kauffman, Austin, TX (US)

(73) Assignee: CKL Distilling, LLC d/b/a Desert Door, Driftwood, TX (US)

(21) Appl. No.: 17/163,008

(22) Filed: Jan. 29, 2021

Related U.S. Application Data
(60) Provisional application No. 62/968,055, filed on Jan. 30, 2020.

(51) Int. Cl. C12G 3/02

(52) U.S. Cl. CPC C12G 3/02

(57) ABSTRACT

A process for the production of sotol by the fermentation of Dasylirion wheeleri, Dasylirion leophyllum or Dasylirion texanum using a novel methodology and apparatus is disclosed. The sotol is prepared by the process of cutting away spiky and thorn covered leaves from hearts of the harvested sotol plants; splitting and roughly shredding the hearts of the sotol plants; steaming the split and shredded hearts of the sotol plants under pressure; squeezing the steamed sotol hearts using a press to obtain an aqueous extract; and fermenting the aqueous extract to obtain sotol. The manufacturing process of the present invention provides a steady, manageable and predictable heat source, thereby allowing consistent replication of process conditions from batch to batch.

### PRIORITY STATEMENT UNDER 35 U.S.C. § 119 & 37 C.F.R. § 1.78

This non-provisional application claims priority based upon prior U.S. Provisional Patent Application Ser. No. 62/968,055 filed Jan. 30, 2020 in the names of Brent Looby, Ryan Campbell, and Judson Kauffman, entitled “METHOD AND APPARATUS FOR PRODUCING SOTOL,” the disclosures of which are incorporated herein in their entirety by reference as if fully set forth herein.

### BACKGROUND OF THE INVENTION

The present invention relates generally to a process for the production of a distilled spirit beverage by the fermentation of plant parts. More specifically, the present invention relates to a process for the production of sotol by the fermentation of Dasylirion wheeleri, Dasylirion leophyllum or Dasylirion texanum using a novel methodology and apparatus.

Sotol is a type of distilled alcoholic beverage which is similar to Tequila. Sotol is obtained by the fermentation of Dasylirion wheeleri (commonly known as Desert Spoon or, in Spanish, sotol), Dasylirion leophyllum or Dasylirion texanum. Sotol, also called desert spoon is the generic name of 22 species of the Dasylirion genus, a species of flowering plant in the asparagus family asparagaceae, native to arid environments of northern Mexico and in the southwestern United States. Dasylirion texanum is a monocot flowering plant native to central and southwestern Texas. Sotol is obtained by cooking of the central part of sotol plants (known as heart), which are previously fermented and distilled. This alcoholic beverage is very popular and economically important.

Conventionally, in the method of making sotol, the serrated, spiky leaves of the sotol plant, are cut by hand off of the dense core, also referred to as the heart. If harvested carefully, a sotol plant can be harvested without killing the roots, allowing the plant to regenerate for multiple harvests. The hearts of the sotol plants are baked underground in an earthen pit oven made of hardwoods and lined with volcanic stones. The hearts are soaked prior to cooking to prevent burning, as they are extremely dry. Also, to prevent burning, in many cases a wooden stake is carefully placed and driven into the buried pit and several liters of water are quickly poured in to manage hot spots. After being roasted, the sotol plants are shredded in order to open up their fibrous core so that the water and bacteria can easily reach the cooked sugars contained within during the fermentation process. The center of the sotol plant, called the “Choyaca,” must be removed prior to fermentation as it imparts a bitter flavor. The shredded, roasted sotol is loaded into fermentation vats made of cement and lined with pine. Fermentation lasts between 4-8 days depending on the ambient temperature. Once the fermentation is complete, the mash is loaded into the still.

Traditionally, the fermented mash is heated in copper pot. Some producers distill the product more than once. Subsequent distillations are used to better control the cuts of the final distillate. Due to the dryness and low sugar content of the sotol plant, it typically takes about one heart to make a single bottle of sotol.

The traditional method of making sotol is slow and often produces inconsistent results. Also, this traditional process does not have a quality control program. Therefore, there exists a long felt need in the art for providing users with an improved method and system for making sotol. There is also a long felt need in the art for providing a method for producing sotol with good yield. The subject matter disclosed and claimed herein, in one embodiment thereof, comprises a sotol production process from freshly harvested sotol plants, which provides a steady, manageable and predictable heat source, thereby allowing consistent replication of process conditions from batch to batch.

In this manner, the novel method of the present invention accomplishes all of the forgoing objectives and provides a more efficient process for the production of sotol. The method of the present invention can be easily handled and operated. Additionally, the method of the present invention provides a good yield of sotol. Finally, the sotol produced by the process of the present invention provides the same usefulness as conventional sotol.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a process for the production of sotol from freshly harvested sotol plants, wherein the sotol is prepared by the process of cutting away spiky and thorn covered leaves from hearts of the harvested sotol plants; splitting and roughly shredding the hearts of the sotol plants; steaming the split and shredded hearts of the sotol plants under pressure for two to four days at a temperature ranging from 150 to 250° F.; squeezing the steamed sotol hearts using a press to obtain an aqueous extract; and fermenting the aqueous extract for five to six days to obtain sotol. The manufacturing process of the present invention provides a steady, manageable and predictable heat source, thereby allowing consistent replication of process conditions from batch to batch.

The subject matter disclosed and claimed herein, in another important embodiment thereof, comprises an assembly for preparing sotol from freshly harvested sotol plants, wherein the assembly is comprised of a steaming basket; a retort; a heat source with temperature regulation mechanism; a press; a filter assembly; and a fermentation vessel. With the use of the assembly of the present invention, the sotol plants can be efficiently and consistently processed into a distilled spirit.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### DESCRIPTION OF THE DRAWINGS

For a more complete understanding of the present invention, and the advantages thereof, reference is now made to the following descriptions taken in conjunction with the accompanying drawings in which:

FIG. 1 illustrates a front perspective view of a custom steaming basket in a door opened condition from the production assembly of the sotol production process of one potential embodiment of the present invention.

FIG. 2 illustrates a front perspective view of a custom steaming basket in a door closed condition from the production assembly of the sotol production process of one potential embodiment of the present invention.

FIG. 3(a) illustrates a right-side view of a retort used in the sotol production process of one potential embodiment of the present invention.

FIG. 3(b) illustrates a perspective view of a retort from the production assembly of the sotol production process of one potential embodiment of the present invention.

FIG. 4(a) illustrates a front left perspective view of a screw press from the production assembly of the sotol production process of one potential embodiment of the present invention.

FIG. 4(b) illustrates a right-side view of a screw press from the production assembly of the sotol production process of one potential embodiment of the present invention.

FIG. 4(c) illustrates a top view of a screw press from the production assembly of the sotol production process of one potential embodiment of the present invention.

### DESCRIPTION OF THE PREFERRED EMBODIMENTS

The innovation is now described with reference to the drawings and embodiments, wherein like reference numerals are used to refer to like elements throughout. In the following description, for purposes of explanation, numerous specific details are set forth in order to provide a thorough understanding thereof. It may be evident, however, that the innovation can be practiced without these specific details.

As noted above, there exists a long felt need in the art for providing users with an improved method and system for making sotol. There is also a long felt need in the art for providing a method for producing sotol with good yield. The problem to be solved by the present invention is to change the existing sotol production process to make it more efficient. In order to solve the above technical problems, the present invention adopts a new technical route for sotol production and an additional pressure steaming process. The plants are pressure steamed to convert the long chain sugar, inulin, into fermentable sugars such as glucose, fructose, and sucrose and to maximize the aqueous sugar solution obtained from the plants. The pressure-steaming process of the present invention provides a steady, manageable and predictable heat source, thereby allowing consistent replication of process conditions from batch to batch.

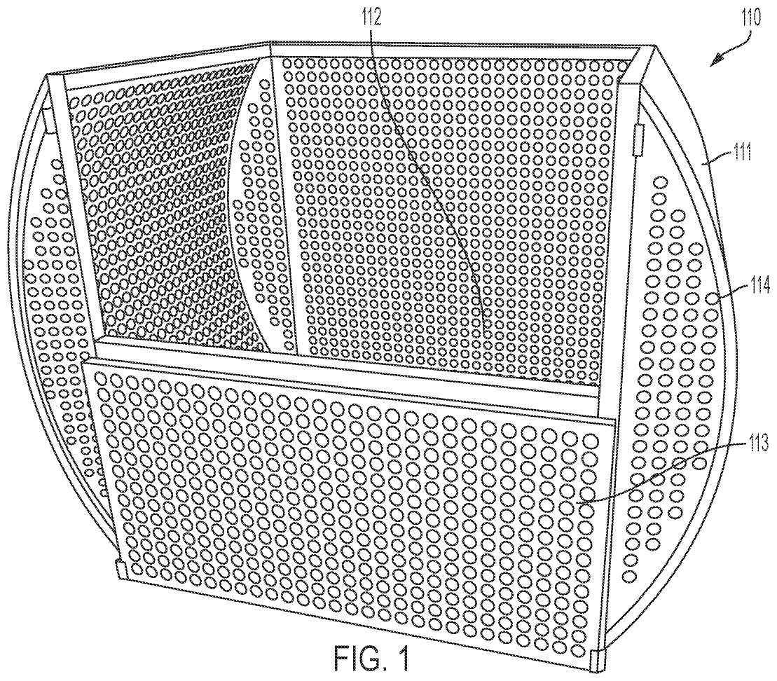

Referring initially to the drawings, FIG. 1 illustrates a perspective view of the custom steaming basket (110) in a door opened condition from the production assembly of the sotol production process of one potential embodiment of the present invention in accordance with various embodiments of the disclosed invention. The steaming basket (110) is used to carry the sotol plant hearts for steaming. The steaming basket (110) comprised of an outer body (111) forming a hollow interior space (112) which contain sotol plant hearts for steaming, and a door (113) system. The steaming basket (110) is perforated and comprises plurality of holes (114), either of similar size and shape or different. The holes (114) allow the passage of steam inside the basket.

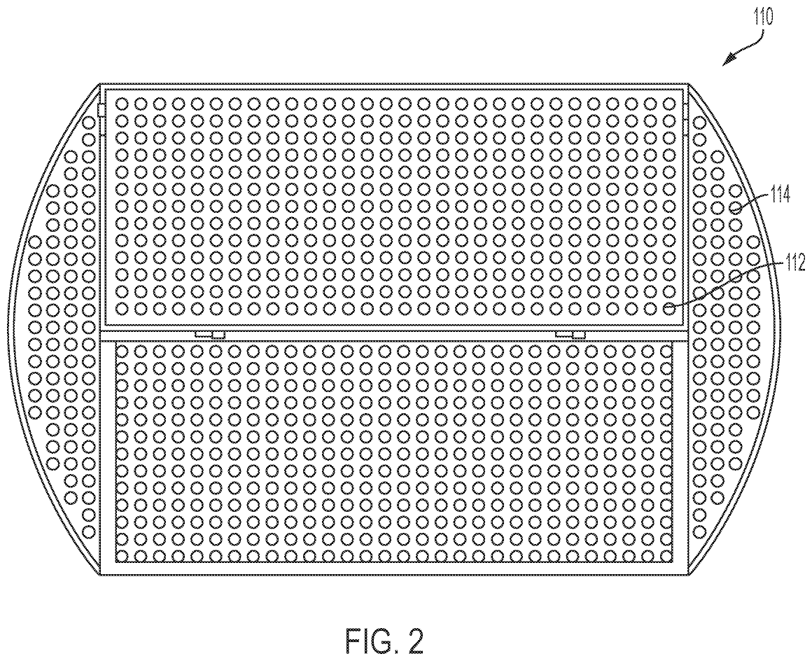

FIG. 2 illustrates a perspective view of the custom steaming basket (110) in a door closed condition from the production assembly of the sotol production process of one potential embodiment of the present invention. The steaming basket (110) is used in the door closed condition for steaming operation.

In an embodiment, the steaming basket (110) can be constructed from any suitable heat resistant material such as stainless steel, aluminum, steel, titanium, enameled steel plate, wood, heat-resistant synthetic resin, phenol resin, polypropylene, heat-resistant plastic resin, polycarbonate resin, polyamide, polyethylene terephthalate, polyphenylene sulfide (PPS) resin, crystal glass, soda glass, quartz glass, borosilicate-resistant heat glass, Pyrex glass, natural rubber, fluorine rubber, silicone rubber, urethane rubber, neoprene rubber (trade name), heat-resistant acrylic rubber, chloroprene rubber, nitrile rubber, ethylene propylene rubber, butyl rubber and the like are preferred.

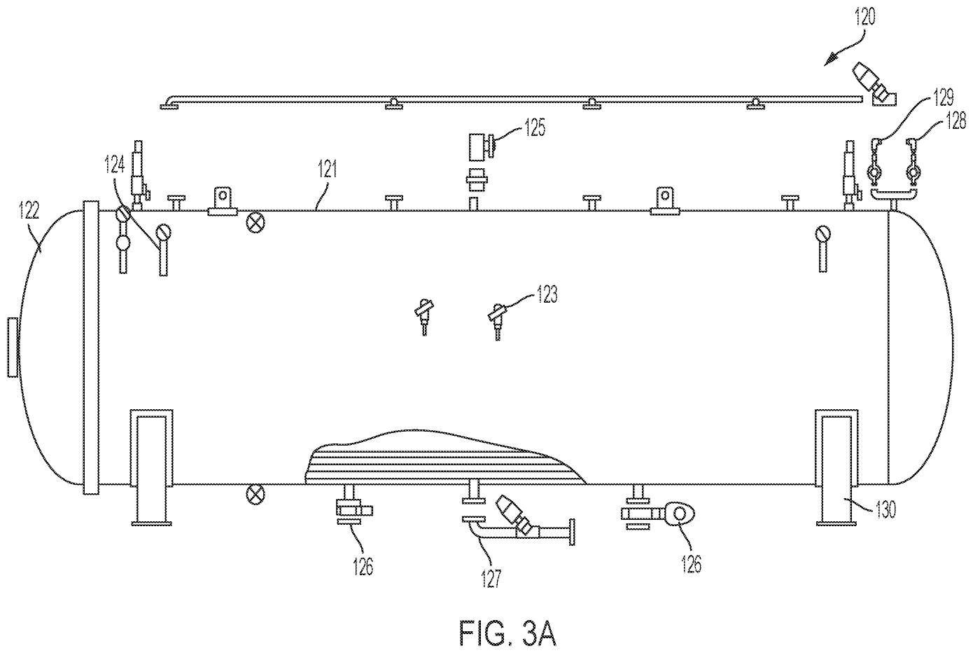

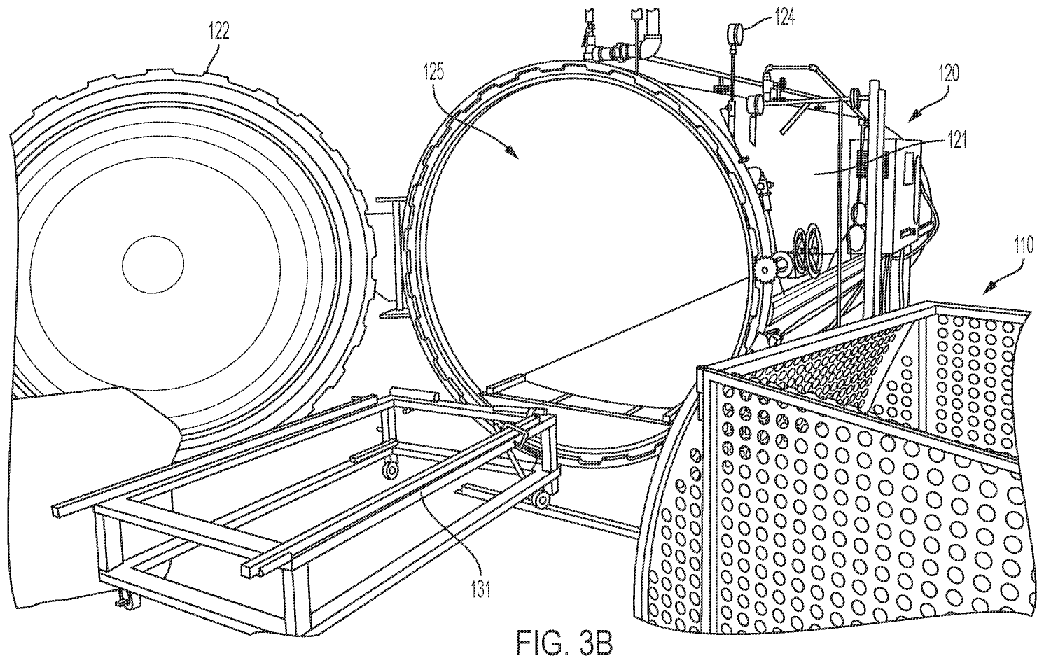

FIG. 3(a) illustrates a right-side view and FIG. 3(b) illustrates a front perspective view of the retort (120) from the production assembly of the sotol production process of one potential embodiment of the present invention. The retort (120) comprises of an outer body (121) forming a hollow interior space (125) to contain steaming basket (110), a retort cap (122) for opening and closing purpose, a temperature sensor unit (123) to maintain desired temperature inside the retort, a pressure gauge (124) to measure the pressure of steam inside the retort, a compressed air inlet unit (126) for sending compressed air into the retort, a steam inlet mouth (127) for sending steam inside the retort, a pressure valve (128) to release extra pressure, a safety valve (129) and a set of stands (130) for positioning on the floor. A cart (131) for moving steaming baskets (110) in and out of the interior space (125) of the retort (120)

The retort (120) is used for steaming the hearts of the sotol plants under pressure. These types of retorts can be configured either vertically, in which case the steaming baskets (120) are lowered by a hoist into the retort (120), or horizontal, in which case the steaming baskets (120) may be pushed or pulled into the retort (120). The steam retort (120) provides an efficient and reliable process for transferring heat and allows for the easy regulation of temperature, thereby increasing the consistency of the process and the predictability of the final product.

The steam retort (120) provides several advantages in the production process of sotol. It provides an excellent medium for the heat transfer. The temperature inside a retort can be easily regulated. The steam pressure required in the retort to achieve the required processing temperature serves to counterbalance the pressure built up inside the retort (120) during processing. Steam can be easily generated and can be held in reserve for immediate use.

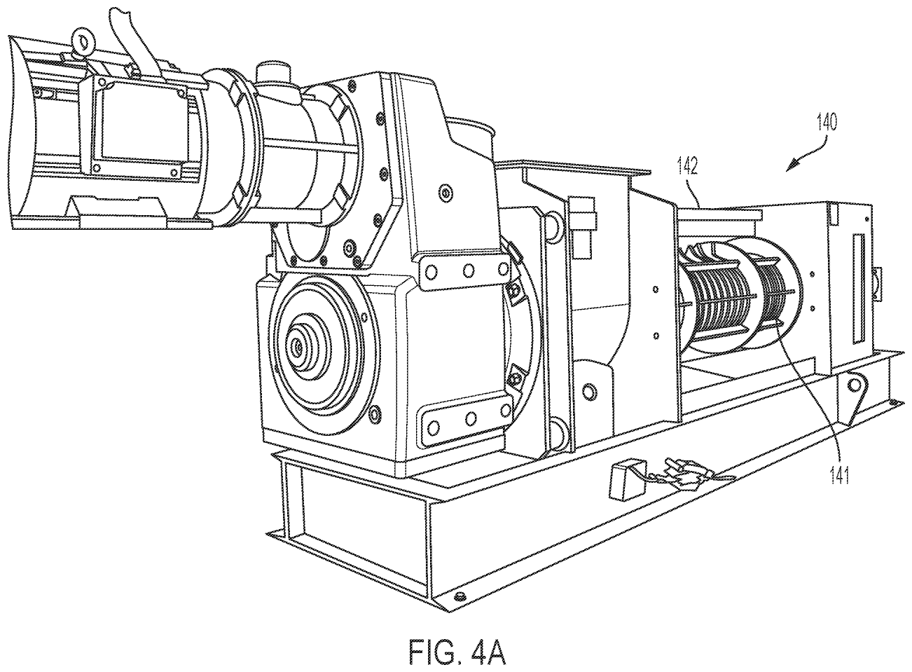

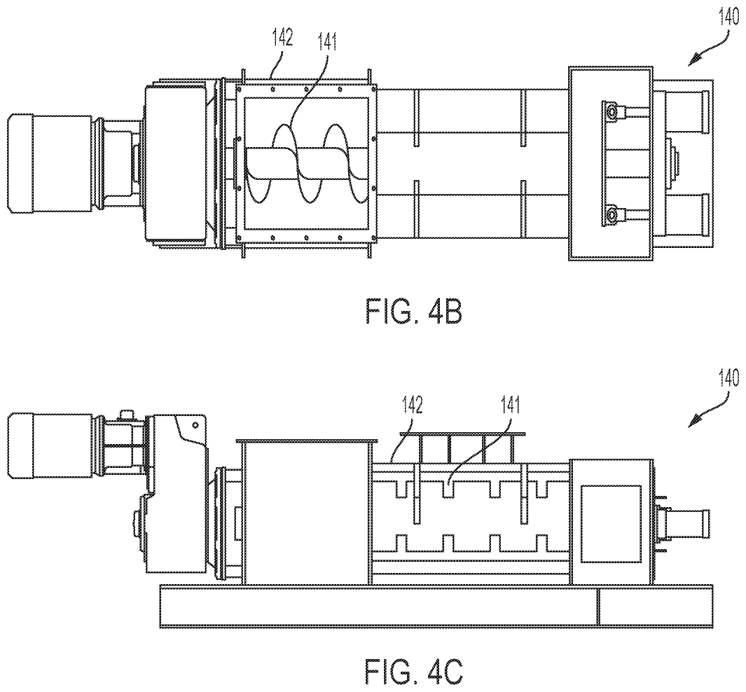

FIG. 4(a) illustrates a front left perspective view, FIG. 4(b) illustrates a right-side view, and FIG. 4(c) illustrates a top view of the screw press (140) from the production assembly of the sotol production process of one potential embodiment of the present invention. The screw press (140) majorly comprises an auger (141), a casing (142), an intake, a screen or filter, a liquid output and a solid output. The screw press (140) is a simple, slow moving device that accomplishes dewatering by continuous gravitational drainage. The press squeezes the steamed sotol hearts against a screen or filter and the aqueous extract is pressed through the screen for collection and use. The auger (141) is a screw-like member that mechanically forces the steamed plant material fed into the intake through the casing (142) to the solid output. The auger (141) is positioned within the casing (142) preferably, centrally mounted within the case (142).

An important embodiment of the present invention comprises a process for the production of sotol from freshly harvested sotol plants, wherein the sotol is prepared by the following process:
a) cutting away spiky and thorn covered leaves from hearts of the harvested sotol plants;
b) splitting and roughly shredding the hearts of the sotol plants;
c) steaming the split and shredded hearts of the sotol plants under pressure for about three days at a temperature of around 200° F.;
d) squeezing the steamed sotol hearts using a press to obtain an aqueous extract; and
e) fermenting the aqueous extract obtained above for five to six days to obtain sotol.

The process efficiently uses the sotol plant as raw material and mimics the traditional pit oven cooking process to produces an end product that replicates that distinguishing features of the traditional sotol product in a fraction of the time.

In a detailed methodology, the spiky and thorn covered leaves are cut away from the heart of the harvested plant before transporting to the production facility. At the production facility, the heart of the sotol plant is loaded into custom steaming baskets (110) such as that shown in FIG. 1 and FIG. 2. At this stage, the plants can weigh as much as fifty pounds, so the plants are split and roughly shredded to enhance the steaming process. The plants are then pressure steamed to convert the long chain sugar, inulin, into fermentable sugars such as glucose, fructose, sucrose, and to maximize the aqueous sugar solution obtained from the plants.

In various embodiments of the invention, the plants are pressure-steamed in a retort (120), such as shown in FIG. 3(a) and FIG. 3(b), for few days at a particular temperature. These types of retorts (120) can be configured either vertically, in which case the baskets are lowered by a hoist into the retort (120), or horizontal, in which case the baskets (110) may be pushed or pulled into the retort (120) using a cart (131). The steam retort (120) provides an efficient and reliable process for transferring heat and allows for the easy regulation of temperature, thereby increasing the consistency of the process and the predictability of the final product.

In a further process in the production of sotol, the steamed hearts of the sotol plant are next sent through a screw press (140), which extracts liquid laden with fructose and glucose. In various embodiments of the present invention, the press is a screw press (140) such as shown in FIG. 4(a), FIG. 4(b) and FIG. 4(c), and commonly used in dewatering cellulose fiber, although other types of dewatering techniques, such as belt presses, centrifuges, or filter paper may be used. Once again, the use of a screw press (140) in embodiments of the present invention ensures that a consistent amount of pressure is applied from batch-to-batch. In those instances, in which sugar levels vary between batches of the aqueous extract, it may be desirable to add purified water to create consistency between batches before fermenting.

Some embodiments of the present invention further comprise a liquid effluent reservoir or multiple reservoirs for collecting the aqueous extract extracted utilizing the screw press (140). Generally, the casing (142) is in fluid communication with the liquid effluent reservoir through the at least one screen or filter. For example, the liquid effluent reservoir may be positioned beneath the casing (142) such that aqueous extract passing through the screen or filter simply falls into the liquid effluent reservoir. Furthermore, the liquid output is also in fluid communication with the liquid effluent reservoir. More particularly, in some embodiments, a duct can be used, which can be in fluid communication with the liquid reservoir, such that aqueous extract ejected from the screw press (140) passes through the duct and falls into the liquid effluent reservoir.

Next, the aqueous extract is allowed to ferment in a still. In some embodiments, organic, proprietary yeast is added to the aqueous extract and fermentation occurs over five to six days, arriving at an alcohol-by-volume (ABV) between 4-4.5%. At this stage, it may be desirable to add a second yeast for a two-step pitch to produce another 1% or so ABV.

In contrast to the traditional method of preparing sotol plants by baking underground in an earthen pit oven in which the heat varies considerably initially and then dramatically lessens over time, the pressure-steaming process of the present invention provides a steady, manageable and predictable heat source, thereby allowing consistent replication of process conditions from batch to batch.

Therefore, it can be observed that the present invention provides a unique solution to the problem of providing a novel method to produce sotol. A main advantage of the process of the present invention is that it reduces the problem of temperature control associated with conventionally produced sotol. The process is easy to carry and provides good product yield. Hence, a new process technology is developed to produce sotol. Not only can it save time, but it can also make the process more manageable.

Certain terms are used throughout the following description and claim to refer to particular features or components. As one skilled in the art will appreciate, different persons may refer to the same feature or component by different names. This document does not intend to distinguish between components or features that differ in name but not structure or function. As used herein “production” and “synthesis” are interchangeable and refer to a process to produce sotol. Also, the terms “process”, “methodology” and “method” holds the identical dictionary meaning.

Notwithstanding the forgoing, the apparatus used in the process of the present invention for producing sotol and their various structural components can be of any suitable size, shape, color, style and configuration as is known in the art without affecting the overall concept of the invention, provided that it accomplishes the above stated objectives. One of ordinary skill in the art will appreciate that the shape and size of the apparatus and their various components, as show in the FIG. 1 to FIG. 4(c) are for illustrative purposes only, and that many other shapes, sizes and arrangement of the various equipment are well within the scope of the present disclosure. Although dimensions of the apparatus (i.e., length, width, and height) are important design parameters for good performance, the apparatus and their components may be in any shape, size, color and style that ensure optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

To aid the Patent Office and any readers of any patent issued on this application in interpreting the claims appended hereto, the applicant wishes to note that it does not intend any of the appended claims or claim elements to invoke 35 U.S.C. 112(f) unless the words “means for” or “step for” are explicitly used in the particular claim.

We claim:

1. A method for preparing sotol from freshly harvested sotol plants, comprising:
a) cutting away spiky and thorn covered leaves from hearts of harvested sotol plants;
b) splitting and roughly shredding the hearts;
c) steaming split and shredded hearts of the sotol plants under pressure for two to four days at a temperature ranging from 150 to 250° F.;
d) squeezing steamed sotol hearts using a press to obtain an aqueous extract; and
e) fermenting the aqueous extract for five to six days to obtain sotol.

2. The method for preparing sotol according to claim 1, wherein the method is a batch process.

3. The method for preparing sotol according to claim 1, wherein the method is a continuous process.

4. The method for preparing sotol according to claim 1, wherein the steaming of the split and shredded hearts of the sotol plants takes place for three days.

5. The method for preparing sotol according to claim 1, wherein the steaming of the split and shredded hearts of the sotol plants takes place at a temperature of 200° F.

6. The method for preparing sotol according to claim 1, wherein the steaming of the split and shredded hearts of the sotol plants takes place in a retort.

7. The method for preparing sotol according to claim 6, wherein the retort is configured vertically.

8. The method for preparing sotol according to claim 6, wherein the retort is configured horizontally.

9. The method for preparing sotol according to claim 1, wherein the press is a screw press.

10. The method for preparing sotol according to claim 1, wherein the press is a belt press.

11. The method for preparing sotol according to claim 1, wherein a first yeast is added to the aqueous extract for fermentation to occur for five to six days, bringing at an ABV (alcohol by volume) between 4 and 4.5%.

12. The method for preparing sotol according to claim 11, wherein a second yeast is further added for a two-step pitch to produce another 1% ABV (alcohol by volume).

13. An assembly for preparing sotol from freshly harvested sotol plants, comprising:
a) a steaming basket;
b) a retort;
c) a heat source with temperature regulation mechanism;
d) a press;
e) a filter assembly; and
f) a fermentation vessel.
